(19) United States
(12) Patent Application Publication
(10) Pub. No.: US 2011/0211507 A1
(43) Pub. Date: Sep. 1, 2011

(54) SYSTEM AND METHOD FOR COMMUNICATING DATA TO ELECTRONIC DISPLAYS POSITIONED IN A RETAIL ESTABLISHMENT

(75) Inventors: Robert I. Wolinsky, Fairfield, CT (US); Richard Lefkowitz, Suffern, NY (US); Robert Thompson, Parsippany, NY (US)

(73) Assignee: Automated Media Services, Inc.

(21) Appl. No.: 13/033,239

(22) Filed: Feb. 23, 2011

Related U.S. Application Data
(60) Provisional application No. 61/307,229, filed on Feb. 23, 2010.

(51) Int. Cl. H04B 7/00; H04B 3/54

(52) U.S. Cl. 370/310; 307/1

(57) ABSTRACT

A system and method for communicating data in a retail establishment may include receiving data by a wireless transceiver configured to service multiple electronic display devices positioned on a gondola and in electrical communication with the wireless transceiver. The received data may be communicated to the electronic display devices via a wireline by the wireless transceiver. A power converter may be electrically connected to the wireline and be configured to convert power from a high level to a low level for powering the electronic display devices, and the wireless transceiver may be electrically connected between the power converter and the electronic display devices.

### RELATED APPLICATIONS

This patent application claims priority to co-pending U.S. Provisional Patent Application Ser. No. 61/307,229 filed Feb. 23, 2010, the entire contents of which are herein incorporated by reference in their entirety.

### BACKGROUND

Data communications in retail environments can be unreliable due to a large amount of metal in the form of gondolas with shelves and other materials, such as consumer, products, within a retail establishment. In addition, because retail establishments need to have a certain level of aesthetic “cleanliness,” the retailers generally desire not to have wires seen by customers. As electronic displays and other electronic devices have been and will continue to be more prolific in retail establishments, efficient, reliable, and aesthetically pleasing infrastructure for communicating data to the electronic devices in the retail establishment are needed.

### SUMMARY

In providing for reliable data communications to electronic devices in retail establishments, the principles of the present invention provide for a wireless transceiver to be connected to a power bus that supplies power to electronic displays for use in delivering data signals to the electronic displays. By connecting the wireless transceiver to the power bus, as opposed to communicating data via power lines of the retail establishment that power the power bus, problems of data communication through a power converter are eliminated and reliability of communicating data to the electronic displays is improved.

One embodiment of a system for communicating data to electronic devices operating in a retail establishment may include a power/data bus connected to a gondola. The power bus may be configured to deliver power to the electronic devices supported by the gondola. A power converter may be electrically connected to the power bus, and be configured to convert electrical power from one power level to another for delivery onto the power/data bus. A wireless transceiver may be electrically connected to the power/data bus and be configured to receive and communicate data via the power/data bus to the electronic devices.

One embodiment of a method of installing an electronic display in a retail establishment including installing a power/data bus onto a retail establishment gondola. A power converter may be connected to the power/data bus. An electronic display may be connected to the power/data bus. A wireless transceiver may be connected to the power bus. The wireless transceiver may be electrically connected between the power converter and the electronic display.

One embodiment of a method for communicating data in a retail establishment may include receiving data by a wireless transceiver configured to service multiple electronic display devices positioned on a retail gondola and in electrical communication with the wireless transceiver. The received data may be communicated to the electronic display devices via a wireline by the wireless transceiver. A power converter may be electrically connected to the wireline and be configured to convert power from a high level to a low level for powering the electronic display devices, and the wireless transceiver may be electrically connected between the power converter and the electronic display devices.

### BRIEF DESCRIPTION

A more complete understanding of the method and apparatus of the present invention may be obtained by reference to the following Detailed Description when taken in conjunction with the accompanying Drawings wherein:

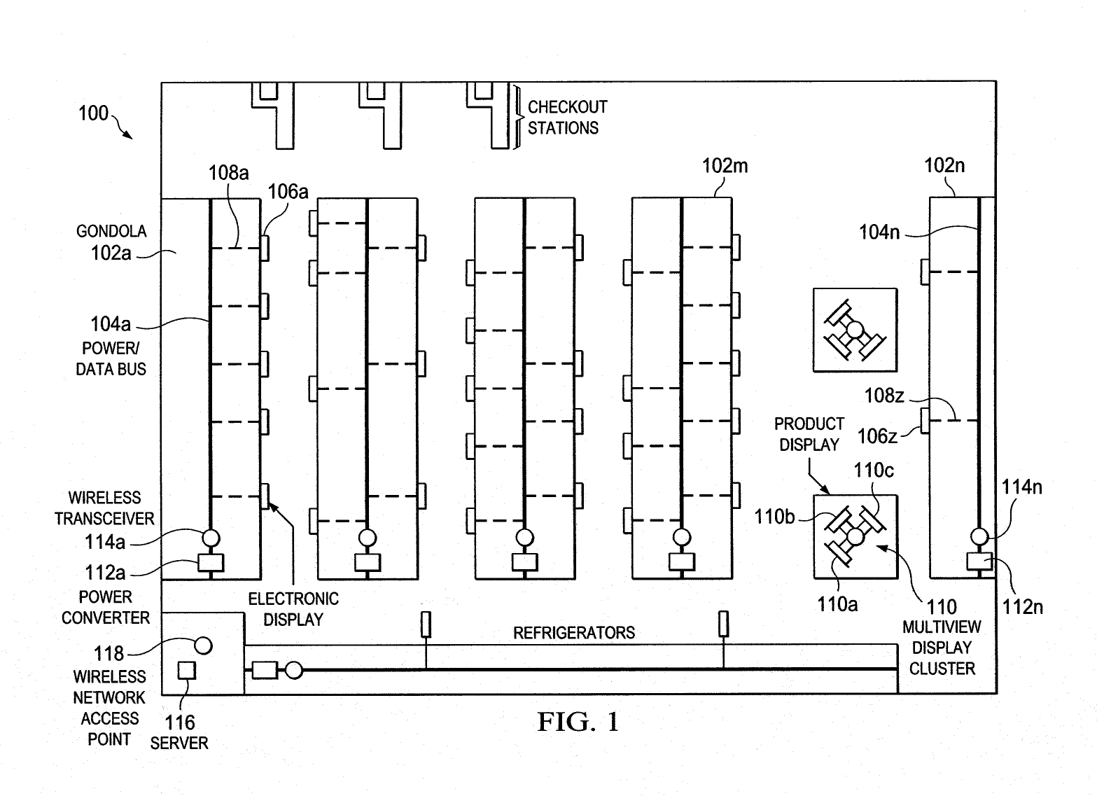

FIG. 1 is an illustration of a retail establishment in which electronic displays are mounted to shelves of gondolas and wireless transceivers are connected to respective power buses connected to the gondolas;

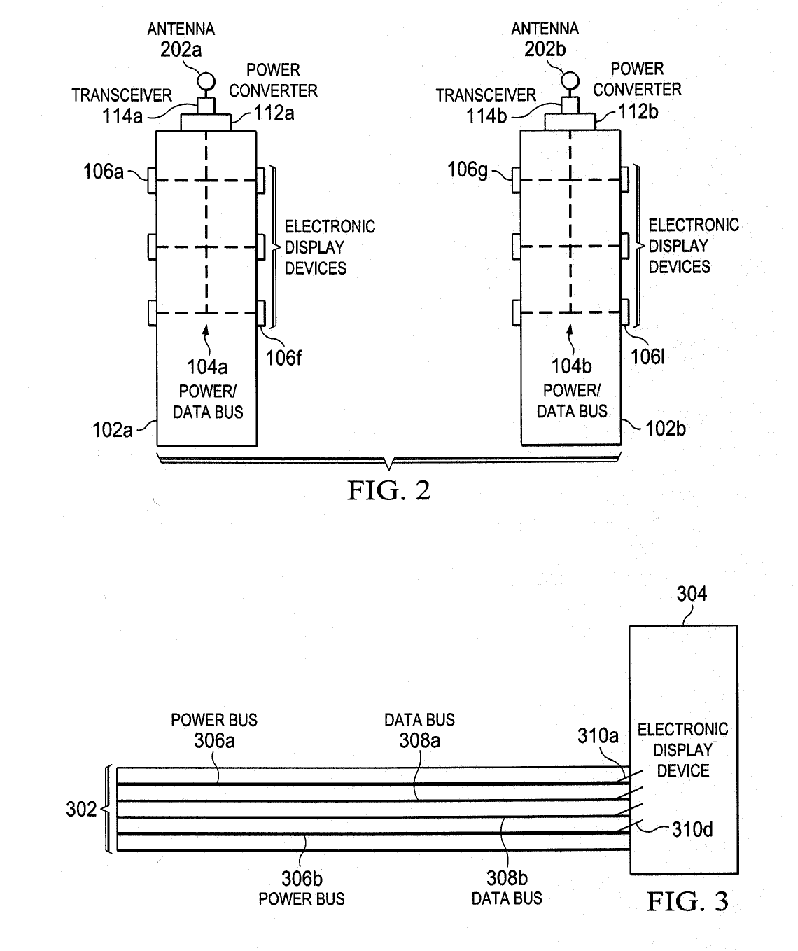

FIG. 2 is an illustration of an illustrative gondolas with electronic display devices mounted to shelves on the gondolas and a power/data bus for providing power and data to the electronic display devices;

FIG. 3 is an illustration of an illustrative power/data bus used to communicate power and data to an electronic display device;

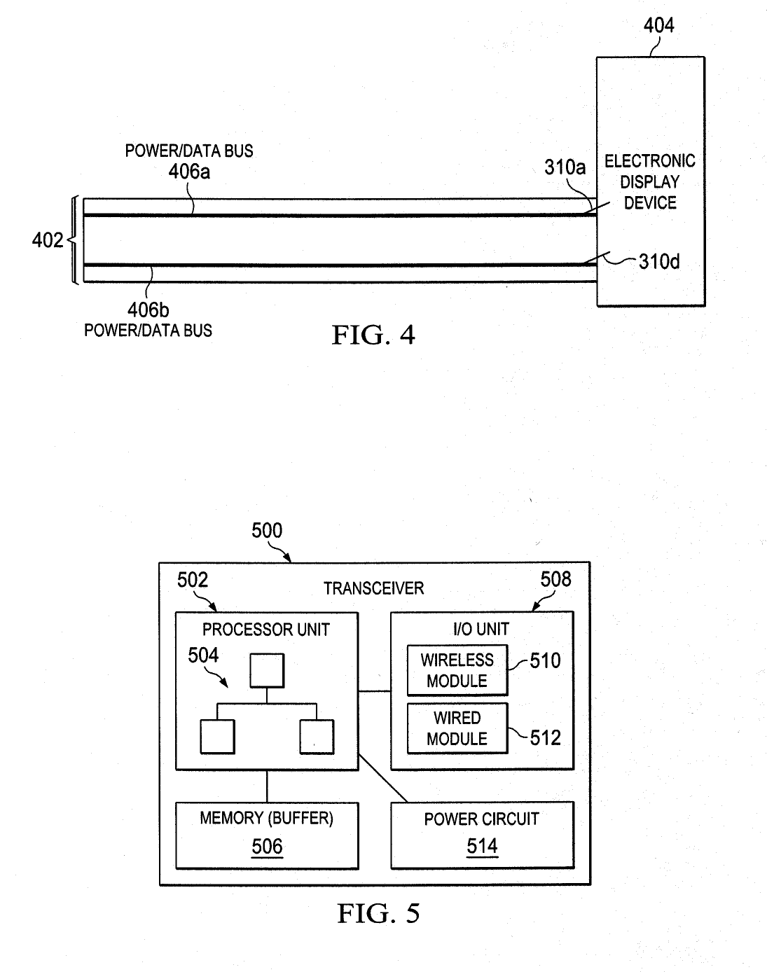

FIG. 4 is an illustration of an illustrative power/data bus for delivering power and data to an electronic display device;

FIG. 5 is an illustration of an illustrative transceiver used to receive and transmit data to a wireless network access point and electronic displays over a power/data bus in a retail establishment;

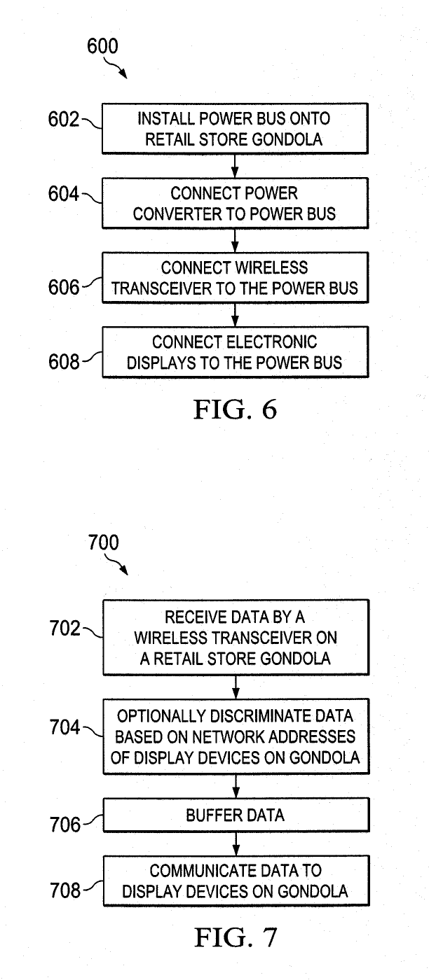

FIG. 6 is a flow diagram of an illustrative process for installing a wireless transceiver onto a power bus on a gondola in accordance with the principles of the present invention; and

FIG. 7 is a flow diagram of an illustrative process for receiving data at a gondola in a retail establishment and communicating that data to electronic displays on the gondola.

### DETAILED DESCRIPTION

With regard to FIG. 1, an illustrative retail establishment 100 is shown to include gondolas 102a-102n (collectively 102) that are used to display products in the retail establishment 100. Power/data buses 104a-104n (collectively 104) may be attached to the gondolas 102 and used to deliver power on electronic displays 106a-106z that are connected to shelves of the gondolas 102. Power/data bus extension lines 108a-108z (collectively 108) may connect power and/or data lines to each of the electronic displays 106 from the power/data buses 104 that extend along the gondolas 102. As further described herein, the power lines may include high and low power lines, and the data lines may include separate conductors (FIG. 3) or share the power lines (FIG. 4). If the power/data lines 104 are shared, then power line communications (PLC) may be utilized, as understood in the art. In addition to the displays 106 being connected to the gondolas 108, the principles of the present invention provide for non-gondola electronic display configurations, such as a multiview display cluster 110 that includes multiple electronic displays 110a-110c, ceiling mounted electronic displays (not shown), wall mounted electronic displays (not shown), floor mounted electronic displays (not shown), and so forth. In any of these alternative electronic display configurations, a power/data bus may be connected to a structure other than the gondola.

Each of the power/data buses 104 may have power converters 112a-112n (collectively 112) electrically attached and/or physically supported thereto. The power converters 112 may be configured to convert high voltage power level, such as 120V AC, accessible at the retail establishment into low voltage power level DC or AC power, such as 12V DC or AC power. The power converters 112 may include a transformer and/or rectifier circuitry, as understood in the art, for use in the conversion of the power. As understood in the art, data signals that are communicated over power lines have difficulty in crossing through transformers and other power conversion circuitry. As such, the principles of the present invention connect wireless transceivers 114a-114n to the power/data buses 104 on the down-converted power side of the power converters 112.

The retail establishment 100 may include a server 116 that receives data signals from a remote location (e.g., central content distribution system) via a communications network, such as the Internet or satellite network, and communicates the data via a wireless network access point 118 to communicate the content within the retail establishment 100. The wireless network access point 118 may be configured to communicate using a WiFi® or 802.11 wireless communications protocol, as understood in the art. Alternative wireless communications protocols may be utilized in accordance with the principles of the present invention. In one embodiment, the wireless network access point 118 is capable of communicating wireless signals throughout the entire establishment so that a single wireless network access point may be utilized in the retail establishment. Alternatively, multiple network access points 118 may be utilized in larger retail establishments. However, even having a wireless network access point(s) 118 having a signal strength high enough to communicate throughout the entire establishment, it should be understood that because of metal shelving and other materials of products in the retail establishment, that electronic displays 106 that are positioned on lower shelves that are not within a line-of-sight of the wireless network access point(s) 118 may have difficulty in receiving the wireless communications signals. Therefore, by including wireless transceivers 114 on top of the gondolas 102 and communicating the data signals along the power/data bus to the electronic displays 106, each of the electronic displays 106 may receive the communications signals with reduced risk of communications failure due to the metal shelving and products in the retail establishment.

With regard to FIG. 2, two illustrative gondolas 102a and 102b are shown to include a power/data buses 104a and 104b, respectively for delivering power and/or data to and from electronic displays 106a-106f and 106g-106l, respectively. Attached to each of the power/data buses 104a and 104b are power converters 112a and 112b, respectively. As previously described, the power converters 104a and 104b convert electrical power signals provided by the retail establishment into power signals that may be used to power the electronic displays in either AC or DC format. Wireless transceivers 114a and 114b may be connected to respective power/data buses 104a and 104b to receive and distribute data signals to the electronic displays 106 on the respective gondolas 102a and 102b. Antennas 202a and 202b connected to the wireless transceivers 114a and 114b, respectively, may also be utilized to transmit and receive data communications signals with a wireless network access point in the retail establishment, where the wireless network access point may connect to a local or wide area network.

With regard to FIG. 3, an illustration of an illustrative power/data bus 302 in communication with an electronic display device 304 is shown. In one embodiment, the power/data bus 302 includes two power lines 306a and 306b that are used to communicate power signals to power the electronic display device 304. In addition, two data bus lines 308a and 308b are used to communicate data signals to the electronic display device 304. Conductors 310a-310d (collectively 310) may connect the electronic display device 304 to the power/data bus 302. The conductors 310 may have any form, such as wires, spring-loaded posts, etc., for conducting power and/or data, as understood in the art.

With regard to FIG. 4, an illustration of another illustrative power/data bus 402 is connected to an electronic display device 404. In this embodiment, the power/data bus 402 includes only two conductor lines 406a and 406b that may be used to communicate both power and data signals to the electronic display device 404. In this embodiment, the power line communication protocol may be utilized. As understood in the art, the power line communication protocol uses AC power signals so that data signals may be communicated over the power lines. In such an embodiment, the electronic display device 404 may include a rectifier or other power conversion circuitry for powering electronics within the electronic display device 404.

With regard to FIG. 5, a block diagram of an illustrative transceiver 500 that may be used for receiving and transmitting wireless data signals to a network access point in a retail establishment is shown. The transceiver 500 may include a processing unit 502 that executes software 504. A memory 506 may be utilized to operate as a buffer of data that is being received or transmitted in the event that the data cannot be processed and communicated fast enough by an I/O unit 508. The I/O unit 508 may include a wireless module 510 and wired module 512, where each of the modules may be hardware and/or software. The wireless module 510 may be configured to communicate using a wireless communications protocol, such as an 802.11 wireless communications protocol. The wired module 512 may use a wired communications protocol for communicating data signals over transmission lines, such as a power/data bus on a gondola, as previously described. A power circuit 514 may be configured to receive AC or DC power from a power bus to power the transceiver 500. The software 504 may be configured to receive and process data in conjunction with the I/O unit 508. In one embodiment, the software 504 may be configured to establish a communications protocol with one or more electronic displays that are operating on the power/data bus on a gondola. In one embodiment, the processing unit 502 may automatically identify electronic displays that are operating on the power/data bus and establishment identifiers, such as network addresses in the memory 506. The software 504 may further be configured to discriminate data (i.e., filter out and not send the data to the electronic displays) that is being received by the transceiver 500, but not addressed to any electronic displays operating on the same power/data bus on which the transceiver 500 is connected.

With regard to FIG. 6, a flow chart of an illustrative process 600 for configuring a power/data bus and electronic displays to the power/data bus on a gondola is shown. The process 600 starts at 602, where a power/data bus is installed onto a retail establishment gondola. At step 604, a power converter may be connected to the power/data bus. The power converter may convert electrical power of the retail establishment power lines into power signals that are less dangerous and more easily used by electronic devices, such as electronic displays, connected to the power/data bus on the retail establishment gondola. In one embodiment, the power converter may convert 120V AC power into 12V DC power. At step 606, a wireless transceiver is connected to the power/data bus. The wireless transceiver may be configured to receive wireless communications of data, such as video data, and deliver the data via the power/data bus. In one embodiment, the power/data bus may include both power lines and data lines. Alternatively, the power bus may include only power lines, but the wireless transceiver may be configured to communicate data signals over the power lines using power line communications, as understood in the art. At step 608, electronic displays may be connected to the power bus. Other electronic devices, such as audio speakers or otherwise, may be connected to the power bus and be configured receive data communications via the wireless transceiver.

With regard to FIG. 7, a flow diagram of an illustrative process 700 for a wireless transceiver connected to a power/data bus on a gondola to receive and communicate data to electronic display devices on the gondola is shown. The process 700 starts at step 702, where data is received by a wireless transceiver on a retail establishment gondola. The wireless transceiver may receive the data via local wireless communications, such as using WiFi® or other local wireless communications protocol, as understood in the art. At step 704, data may optionally be discriminated by the wireless transceiver based on network addresses of electronic display devices on the gondola. By having the wireless transceiver perform discrimination, the electronic display devices may be offloaded from having to process each data transmission from a network access point, thereby saving processing power needed by the electronic displays. In an alternative embodiment, the electronic displays may include the ability to discriminate data that is being communicated to other electronic devices with different network addresses. At step 706, data may be buffered by the wireless transceiver. In buffering the data, the wireless transceiver may store data that cannot be processed and communicated as fast as data being received by the wireless transceiver. More particularly, data being received by the wireless transceiver using an 802.11 communications protocol is to be converted for delivery via a wireline or other communications protocol, and if that conversion process is not as fast as data being received, then the data being received may be buffered by the wireless transceiver. At step 708, data may be communicated to display devices on the gondola via a power bus or data bus, as previously described herein. In the event that data is being communicated from a electronic display to a server, the wireless transceiver may perform buffering in the same manner.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A system for communicating data to electronic devices operating in a retail establishment, said system comprising:
a power/data bus connected to a gondola, said power bus configured to deliver power to the electronic devices supported by the gondola;
a power converter electrically connected to said power bus, and configured to convert electrical power from one power level to another for delivery onto said power/data bus; and
a wireless transceiver electrically connected to said power/data bus and configured to receive and communicate data via said power/data bus to the electronic devices.

2. The system according to claim 1, wherein the power/data bus has two electrical conductors.

3. The system according to claim 1, wherein the power/data bus has four electrical conductors.

4. The system according to claim 1, wherein said wireless transceiver utilizes an 802.11 communications protocol.

5. The system according to claim 1, wherein the electronic devices are electronic displays.

6. The system according to claim 1, wherein said power converter includes a transformer.

7. The system according to claim 1, wherein said power converter converts AC power to DC power.

8. The system according to claim 1, wherein said power converter is connected to a portion of said power/data bus supported by the gondola.

9. A method of installing an electronic display in a retail establishment, said method comprising:
installing a power/data bus onto a retail establishment gondola;
connecting a power converter to the power/data bus;
connecting an electronic display to the power/data bus; and
connecting a wireless transceiver to the power bus, the wireless transceiver being electrically connected between the power converter and the electronic display.

10. The method according to claim 9, wherein the wireless transceiver utilizes the 802.11 communications protocol.

11. The method according to claim 9, wherein installing the power/data bus includes extending the power/data bus along the length of the gondola and installing extensions from the power/data bus to front edges of shelves at which the electronic displays are mounted.

12. The method according to claim 9, wherein connecting the power converter further includes connecting the power converted to a source power line from the retail establishment.

13. The method according to claim 9, wherein the power/data bus includes two conductors, and wherein the wireless transceiver is configured to use power line communications for delivering data over the power/data lines, and wherein the power converter is configured to apply an AC power signal on the power/data lines to power the electronic displays.

14. A method for communicating data in a retail establishment, said method comprising:
receiving data by a wireless transceiver configured to service multiple electronic display devices positioned on a gondola and in electrical communication with the wireless transceiver; and
communicating the received data to the electronic display devices via a wireline by the wireless transceiver.

15. The method according to claim 14, further comprising discriminating communications being received by the wireless transceiver that are not addressed to an electronic display in electrical communication with the wireless transceiver.

16. The method according to claim 14, wherein communication the data includes communicating the data via a power bus to which the wireless transceiver is connected.

17. The method according to claim 14, wherein the wireless transceiver is configured to communicate using an 802.11 communications protocol to communicate remotely from the wireless transceiver and a wire line communications protocol to communicate with the electronic display devices.

18. The method according to claim 14, further comprising:
receiving data by a second wireless transceiver configured to service multiple second electronic display devices positioned on a retail establishment gondola, and in electrical communication with the second wireless transceiver; and
communicating the data to the second electronic display devices via a wireline by the second wireless transceiver.

19. The method according to claim 14, further comprising discriminating communications being received by the second wireless transceiver that are not addressed to one of the second electronic display devices in electrical communication with the second wireless transceiver.

20. The method according to claim 14, wherein receiving the data includes receiving the data from a wireless network access point operating in the retail establishment.
